(19) United States
(12) Patent Application Publication
(10) Pub. No.: US 2012/0320705 A1
(43) Pub. Date: Dec. 20, 2012

(54) STIRRING ARM FOR MIXING SLURRY MATERIAL

(76) Inventor: Ben Floan, Andover, MN (US)

(21) Appl. No.: 13/527,317

(22) Filed: Jun. 19, 2012

Related U.S. Application Data
(60) Provisional application No. 61/498,895, filed on Jun. 20, 2011.

(51) Int. Cl. B01F 15/02

(52) U.S. Cl. 366/153.3; 366/150.1

(57) ABSTRACT

A mixing device for concurrently mixing a slurry and conveying it along an axis of a housing. A shaft having a vane or vanes mounted thereto is disposed within a housing. Rotation of the shaft serves to convey the slurry material along with effecting mixing of the slurry.

### CROSS-REFERENCE TO RELATED APPLICATIONS

This is a regular application filed under 35 U.S.C. 111(a) claiming priority, under 35 U.S.C. §119(e)(1), of provisional application Ser. No. 61/498,895, previously filed Jun. 20, 2011, under 35 U.S.C. §111(b).

### TECHNICAL FIELD

The present invention deals broadly with the field of equipments for mixing slurries which comprise various powder, particulate and/or liquid components. It is an apparatus that fosters both agitation of the various components so as to render them substantially homogeneous, and transmits the slurry in an axial direction (that is, generally along an axis along the slurry is intended to be transmitted).

### BACKGROUND OF THE INVENTION

Equipments for mixing together components of a slurry are known in the prior art. For example, cement powder, gravel and water are mixed together to form a slurry. It is only when the slurry is formed that it can be used for its intended purpose.

One embodiment of a structure having a housing that can be used for this purpose is generally circularly cylindrical in shape. The housing, it is typical, is oriented for use such that its axis of transmission is oriented substantially vertically. The housing within which processing occurs includes a generally circularly cylindrical stirring chamber. A slowly rotating shaft within the chamber includes one or more arms extending from the shaft. At least one arm is positioned proximate the bottom of the stirring chamber to limit the amount of stagnant material within the chamber.

Prior art structures, however, have a number of shortcomings and deficiencies. Conventional stirring systems do not quickly achieve the desired end result. Some areas of the stirred slurry may experience stagnation in certain locations. Some portions of the stirred mass may experience stagnation in locations where parts of the mass are trapped for long periods of time. Quick sweeping of newly-introduced slurry material can result in poor mixing. Poor mixing near the wall defining the mixing chamber can reduce the effectiveness of the machine. More time in the chamber can, therefore, be required. Increasing the stirring time may increase the amount of energy required for stirring. Throughput can be reduced which can, in turn, reduce the overall energy efficiency of the apparatus.

It is to these shortcomings and deficiencies of the prior art that the present invention is directed. It is an apparatus which facilitates agitation of the slurry mass. The present invention is an improved stirring arm for mixing slurry materials.

### SUMMARY OF THE INVENTION

The present invention serves to efficiently and economically mix a slurry and concurrently convey the slurry along an axis of the housing in which the slurry is received. It includes a shaft mounted within the housing generally along an axis of the housing. The shaft is disposed for rotation to convey the slurry through the housing. At least one vane is attached to a surface of the shaft and disposed at an oblique angle relative to the axis. Because of the disposition of the vane, as the shaft rotates, the slurry in the housing is driven along the axis and concurrently mixed to render the slurry generally homogeneous.

In another embodiment of the invention, the vane is a substantially continuous helix which extends from one end of the shaft to an opposite end. Such a vane functions as would an auger.

In another embodiment, one or more segments of such a substantially continuous helix define the vane structure. It will be understood that multiple segmented portions of the helical vane structure are specifically contemplated as being in accordance with the invention.

The present invention is thus an improved structure for mixing and conveying slurries. More specific features and advantages obtained in view of those features will be apparent with reference to the accompanying claims and drawing figures.

### BRIEF DESCRIPTION OF THE DRAWINGS

FIG. 1 is a perspective view of a portion of the present inventive stirring apparatus;

FIG. 2 is an elevational view of a portion of the apparatus;

FIG. 3 is an elevational view, similar to FIG. 2, with the mixing arm in a direction opposite that of FIG. 2; and

FIG. 4 is a perspective view of a second embodiment of the invention.

### DETAILED DESCRIPTION OF THE INVENTION

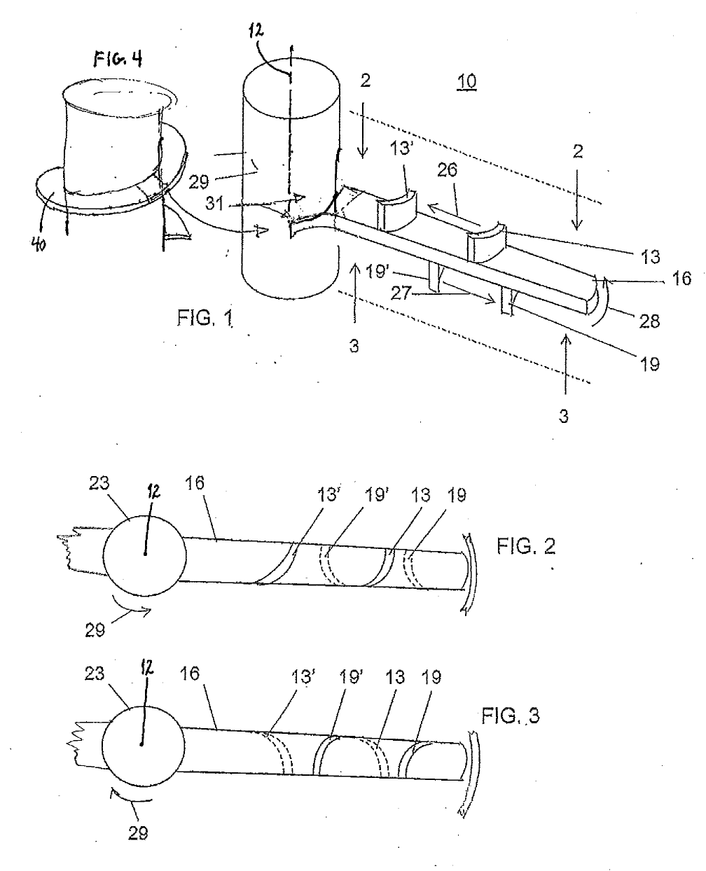

Referring now to the drawing figures wherein like reference numerals denote like elements throughout the several views, FIGS. 1-3 illustrate a first embodiment of the invention. FIG. 1 shows a shaft 23, which, it is intended, would be mounted within a housing (not shown) for rotation about an axis 12 of the housing. It will be understood that the shaft of the arm 16 is intended to be substantially coaxial with the shaft 23.

The housing defines a chamber (not shown) within which the shaft 23 rotates. Shaft 23 is intended to rotate within the chamber in a direction as indicated by arrow 29.

The figures illustrate at least one arm 16 attached at shaft 23. The arm or arms 16 are fixed to shaft 23 at a proximal end thereof and extend radially almost to the inner wall of the chamber.

Arm 16 includes axially-facing opposite sides. Typically, shaft 23 would carry two or more arms 16. The directions of diversion of the arms 16 from shaft 23 would, it is understood, be different. Pairs of arms might be made to extend in directions opposite to each other.

Arm 16 is provided with at least one stirring vane 13. Stirring vanes are attached to the first side of arm 16 and extend generally axially from that side of arm 16. Arm 16 has two similar stirring vanes 13, 13′ positioned at different radial locations along arm 16. Vanes 13, 13′ may, if desired, be provided with a degree of curvature. Alternatively, they may be flat. In any case, vanes 13, 13′ are positioned obliquely with respect to the axis 12.

The leading edge of each vane 13, 13′ could be at a radius different from its trailing edge so as to provide the desired obliqueness. If desired, a degree of curvature could be provided at the leading edge of the vane 13, 13′. FIGS. 2 and 3 show the radial offset of the leading and trailing edges of vanes 13, 13′. If the leading edges or corners of vanes 13, 13′ are at greater radii than the trailing edges thereof as FIGS. 2 and 3 show, stirred mass adjacent to the first side of arm 16 will be shifted radially inward toward shaft 23 with each sweep of arm 16 as arrow 26 indicates.

Arm 16 may also have vanes 19, 19′ on its second side. Such vanes 19, 19′ are shown as projecting axially from the second side of arm 16 away from vanes 13, 13′. As shown in the figures, the leading edges of vanes 19, 19′ are at smaller radii than their respective trailing edges. Consequently, as shaft 23 is made to rotate, vanes 19, 19′ tend to shift the stirred slurry mass near to the second side of arm 16 toward shaft 23 as arrow 27 reflects.

With the radial offsets of vanes 13, 13′ opposite to that of vanes 19, 19′, arm 16, as it rotates, facilitates a slow circulation of the stirred slurry mass. It is important to note that the portion of the slurry mass near the end of arm 16 and the adjacent stirring chamber wall tends to shift axially with each pass of arm 16. Similarly, stirred mass slurry adjacent shaft 23 tends to shift axially with each pass of arm 16. A via (not shown) or shaped profile adjacent to shaft 23 may serve to facilitate circulation near the shaft 23.

Accordingly, over a number of rotations of arm 16, the slurry mass near the end of arm 16 tends to shift axially to potentially eliminate stirred mass stagnation near the wall of the stirring chamber and near the shaft 23 (that is, at the proximal and distal ends of arm 16). The vane size, shape, radial position and leading/trailing edge of the radial offset; number of vanes; and shaft 23 rotational speed may have relatively wide ranges. Such design parameters will likely be made to depend greatly on the stirring purpose. That is, factors such as mixing, heat transfer, and circulation, type of material involved, energy efficiency desired, chamber construction and allotted time for achieving the end result are all factors to be considered. Other considerations may dictate a range of sizes of vanes as a function of radial position, range of radial positions for the vanes, and range of the number and shape of the vanes.

It will be understood that some processes may operate more successfully if shaft 23 carries an integral auger blade in addition to the stirring arm 16. The auger blade (not shown) may have a twist urging material either upwardly or downwardly with shaft 23 rotation. Such an auger blade may reduce stagnation of the slurry material adjacent to shaft 23 and lead to quicker and more uniform mixing.

FIG. 4 illustrates an alternative embodiment of the invention. The vane of that figure is a substantially continuous single helical vane 40. While the vanes of FIGS. 1-3 might be only segments of what would otherwise be a continuous helical vane, the vane of FIG. 4 is, in fact, a single continuous helical vane.

It will be understood that this disclosure, in many respects, is only illustrative. Changes may be made in details, particularly in matters of shape, size, material, and arrangement of parts without exceeding the scope of the invention. Accordingly, the scope of the invention is as defined in the language of the appended claims.

What is claimed is:

1. Apparatus for mixing a slurry and concurrently conveying the slurry along an axis of a housing in which the slurry is received, comprising:
a shaft mounted within said housing generally along the axis, said shaft disposed for rotation to convey the slurry through the housing; and
a vane attached to a surface of said shaft, said vane disposed at an oblique angle relative to the axis;
wherein, as said shaft rotates, the slurry is driven along the axis and mixed to render the slurry generally homogeneous.

2. Apparatus in accordance with claim 1 wherein said vane is a substantially continuous helix extending from one end of said shaft to another.

3. Apparatus in accordance with claim 2 wherein said vane comprises a segment of said substantially continuous helix.

4. Apparatus in accordance with claim 3 further comprising a plurality of said segments.
